(19) United States
(12) Patent Application Publication
(10) Pub. No.: US 2019/0197989 A1
(43) Pub. Date: Jun. 27, 2019

(54) PROCESSING DEVICE, DISPLAY SYSTEM, AND NON-TRANSITORY COMPUTER-READABLE STORAGE MEDIUM

(71) Applicant: SEIKO EPSON CORPORATION, Tokyo (JP)

(72) Inventor: Fusashi KIMURA, Matsumoto-shi (JP)

(73) Assignee: SEIKO EPSON CORPORATION, Tokyo (JP)

(21) Appl. No.: 16/229,630

(22) Filed: Dec. 21, 2018

(30) Foreign Application Priority Data
Dec. 22, 2017 (JP) 2017-246913

(51) Int. Cl. G09G 5/12; G06F 3/14; G09G 5/00; G06F 9/54

(52) U.S. Cl. CPC G09G 5/12; G06F 3/1423; H04M 1/0202; G06F 9/541; G09G 5/003

(57) ABSTRACT

A processing device including a camera, a sensor, a calculation unit that executes an application, and a communication unit that communicates with an external device, includes an image source switching unit that, when a display device including a camera and a sensor is coupled, switches between an image from the camera included in the processing device and an image from the camera included in the display device received via the communication unit and provides the images to the application program in response to input of a switching instruction, and a sensor switching unit that switches between sensor data from the sensor included in the processing device and sensor data from the sensor included in the display device received via the communication unit and provides the sensor data to the application program.

### BACKGROUND

### 1. Technical Field

The invention relates to a processing device capable of cooperating with a display device, a display system, and a program of the processing device.

### 2. Related Art

There is known a head mounted display (HMD) device including a sensor that detects a direction and a moving state of a head of a user and a camera that acquires an environment image in a visual field range of a wearer. The sensor is, for example, a nine-axis sensor detecting acceleration (three-axis), angular velocity (three-axis), and geomagnetism (three-axis).

On the other hand, a mobile information terminal such as a smartphone also includes a nine-axis sensor that detects a direction and a moving state of the mobile information terminal and a camera for environment photographing. It is considerable that a greater variety of services can be provided as long as the output from the nine-axis sensor and the camera of the HMD can be used in an application program (hereinafter, also simply referred to as an application) executed on such a mobile information terminal.

In a cooperative operation of the HMD and the mobile information terminal, the application program on the mobile information terminal needs to switch the camera and/or the nine-axis sensor to be used from the camera and the nine-axis sensor included in the mobile information terminal to the camera and the nine-axis sensor included in the HMD.

However, in general, an application executed on a mobile information terminal is created such that a camera or a sensor included in the mobile information terminal is used via an API provided by an OS of the mobile information terminal. In general, an API for using a camera, a sensor, and the like of an external device coupled via a USB and the like, is not included in the OS of the mobile information terminal.

Thus, in order to use the camera, the sensor, and the like of the HMD in the application on the mobile information terminal, it is necessary to recreate the application and/or to modify the OS itself, and it is difficult to utilize an already-developed software asset for the cooperative operation. Here, OS is an abbreviation for Operating System. Further, API is an abbreviation for Application Programming Interface, which is a programming interface used by an application.

JP-A-2016-24524 describes an information processing device that includes an authentication unit authenticating the validity of an application, restricts hardware resources being able to be used by the application and/or limits their functions and performance according to an authentication result.

Further, JP-A-2016-95778 describes an information processing device that groups a plurality of input/output devices for each function and allocates input/output of one device from within a group corresponding to a requested function in response to a request from an application.

Further, JP-A-2015-156186 describes a system that includes an information processing device, an electronic device coupled to the information processing device, and an external device coupled to the information processing device. In this system, the information processing device and the electronic device cooperate with each other by a first driver software included in the information processing device. Further, the electronic device and the external device cooperate with each other via the information processing device by a second driver software included in the information processing device. Then, the first driver software functions as an application that can be called from the second driver software.

However, in any of the related arts described in JP-A-2016-24524, JP-A-2016-95778 and JP-A-2015-156186, the cooperative operation of the HMD and the mobile information terminal accompanied with switching of the camera and the nine-axis sensor can not be realized without recreating the application or the OS.

### SUMMARY

According to the above background, enabling a cooperative operation of an HMD and a mobile information terminal accompanied with switching of a camera and a sensor without recreating an existing application and/or OS of the mobile information terminal is required.

To solve the problems described above, a processing device according to an aspect of the invention including a camera, a sensor, a calculation unit that executes an application program, and a communication unit that communicates with an external device, includes an image source switching unit configured, when a display device including a camera and a sensor is coupled, to switch between an image from the camera included in the processing device and an image from the camera included in the display device received via the communication unit, the image source switching unit providing the images to the application program in response to input of a switching instruction, and a sensor switching unit configured, when the display device is coupled, to switch between sensor data from the sensor included in the processing device and sensor data from the sensor included in the display device received via the communication unit, the sensor switching unit providing the sensor data to the application program in response to the input of the switching instruction.

According to this configuration, a cooperative operation of the display device and the processing device accompanied with switching of the camera and the sensor can be smoothly performed without recreating an existing application program and/or an OS executed on the processing device.

An aspect of the invention further includes a switching input determination unit that determines whether a switching instruction has been input based on the sensor data from the sensor included in the display device.

According to this configuration, the switching between the camera and the sensor of the processing device and the camera and the sensor of the display device can be easily performed by the user performing an operation which is detectable by the sensor included in the display device.

An aspect of the invention also includes an image acquisition unit that provides a programming interface for acquiring an image from the camera included in the display device received via the communication unit to complement a function of an operating system included in the processing device, and a sensor data acquisition unit that provides a programming interface for acquiring sensor data from the sensor included in the display device received via the communication unit to complement a function of the operating system included in the processing device.

According to this configuration, even in a case where the function of acquiring data from the camera and the sensor of the display device is not provided by the OS executed on the processing device, the cooperative operation of the display device and the processing device accompanied with the switching of the camera and the sensor can be performed smoothly.

Further, in an aspect of the invention, the image source switching unit and the sensor switching unit are implemented by a plug-in program that operates on an operating system to control data transfer between the application program and the operating system, or by an application program that functions as middleware.

According to this configuration, the image source switching unit and the sensor switching unit are implemented as applications executed by the processing device, and thus a smooth cooperative operation of the display device and the processing device accompanied with the switching of the camera and the sensor can be easily realized.

To solve the problems described above, a display system according to an aspect of the invention includes any of the processing devices including a motion sensor as the sensor, and a display device that includes a camera and a motion sensor, and includes a display region configured to enable visual recognition of an outside scene to generate an image in front of a line of sight of the user by the display region when the display device is mounted on a head of the user.

According to this configuration, a display system capable of smoothly performing the cooperative operation of the display device such as an HMD including a camera and a motion sensor and the processing device without recreating the existing application program and/or the OS executed on the processing device can be realized.

To solve the problems described above, a program according to an aspect of the invention is executed by a calculation unit of a processing device, the processing device including a camera, a sensor, the calculation unit that executes an application program, and a communication unit that communicates with an external device, and causes the calculation unit to function as an image source switching unit configured, when a display device including a camera and a sensor is coupled, to switch between an image from the camera included in the processing device and an image from the camera included in the display device received via the communication unit, the image source switching unit providing the images to the application program in response to input of a switching instruction, and a sensor switching unit configured, when the display device is coupled, to switch between sensor data from the sensor included in the processing device and sensor data from the sensor included in the display device received via the communication unit, the sensor switching unit providing the sensor data to the application program in response to input of the switching instruction.

According to this configuration, the cooperative operation of the display device and the processing device accompanied with switching of the camera and the sensor can be smoothly performed without recreating the existing application program and/or the OS executed on the processing device.

### BRIEF DESCRIPTION OF THE DRAWINGS

The invention will be described with reference to the accompanying drawings, wherein like numbers reference like elements.

FIG. 1 is an external view illustrating an HMD and a mobile information terminal constituting a display system according to an exemplary embodiment of the invention.

FIG. 2 is a view illustrating a configuration of an HMD and a mobile information terminal.

FIG. 3 is a view illustrating a configuration of software executed in a control unit of a mobile information terminal.

### DESCRIPTION OF EXEMPLARY EMBODIMENTS

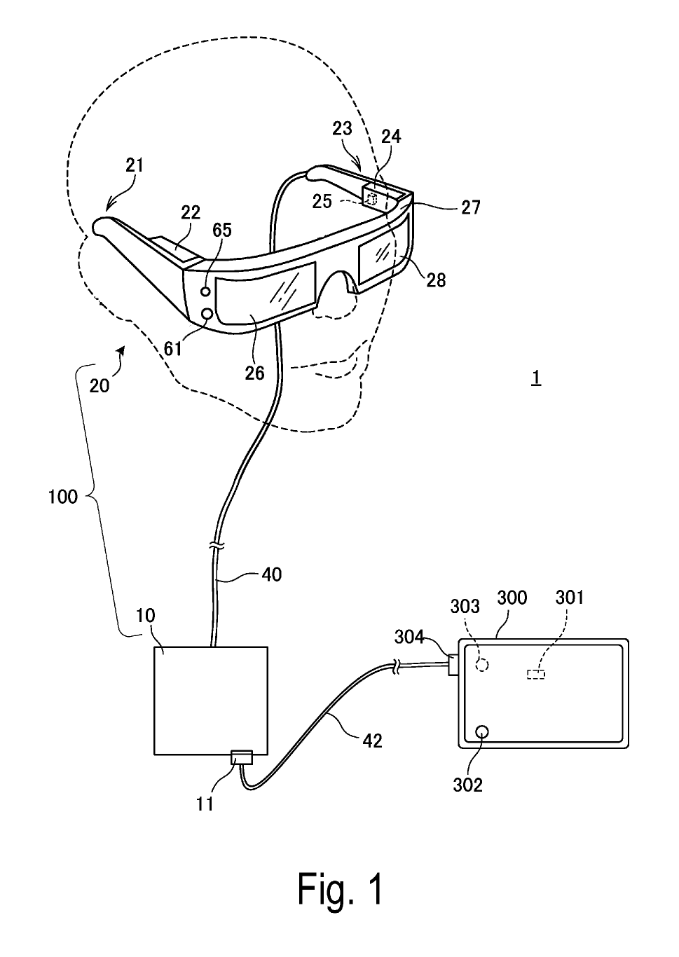

FIG. 1 is a view illustrating a configuration of a display system 1 according to an exemplary embodiment to which the invention is applied.

The display system 1 includes a head mounted display (HMD) 100 serving as a display device, and a mobile information terminal 300 serving as a processing device.

The HMD 100 is a display device including an image display unit 20 that allows a user to visually recognize a virtual image in a state being mounted on the head of the user, and a coupling device 10 that controls the image display unit 20.

The image display unit 20 is a mounting body mounted on the head of the user, and has an eyeglasses-like shape in the exemplary embodiment. The image display unit 20 includes a right display unit 22, a left display unit 24, a right light guide plate 26, and a left light guide plate 28 in a main body including a right holding portion 21, a left holding portion 23, and a front frame 27.

The right holding portion 21 and the left holding portion 23 respectively extend rearward from both end portions of the front frame 27, and hold the image display unit 20 on the head of the user like temples of eyeglasses.

The right display unit 22 and the left display unit 24 are configured with, for example, an organic light emitting diode (OLED) that emits light by organic electro luminescence, and respectively output image light for a right eye and a left eye of the user.

The right light guide plate 26 and the left light guide plate 28 are, for example, prisms. The right light guide plate 26 transmits external light to guide the external light to the right eye of the user, and guides right image light from the right display unit 22 provided in the right holding portion 21 to the right eye of the user, so as to cause the right eye to visually recognize the image. Further, the left light guide plate 28 transmits the external light to guide the external light to the left eye of the user, and guides left image light from the left display unit 24 provided in the left holding portion 23 to the left eye of the user, so as to cause the left eye to visually recognize the image.

Accordingly, the image display unit 20 enables the user to visually recognize an outside scene while causing the user to visually recognize a virtual image and displaying an image by the image light of the right display unit 22 and the left display unit 24. That is, the image display unit 20 functions as a display device that includes a display region configured to enable visual recognition of the outside scene, and generates an image in front of a line of sight of the user by the display region when the display device is mounted on the head of the user.

The image display unit 20 also includes a nine-axis sensor 25 inside the left display unit 24. The nine-axis sensor 25 detects an acceleration (three-axis), angular velocity (three-axis), and geomagnetism (three-axis) of the image display unit 20, and detects a direction and a movement of the head of the user wearing the HMD 100. The nine-axis sensor 25 is configured with, for example, a three-axis acceleration sensor and a three-axis gyro (angular velocity) sensor, which are motion sensors (inertial sensors), and a magnetic sensor that is a three-axis geomagnetic sensor.

The image display unit 20 further includes a camera 61 and an illuminance sensor 65 arranged in the right display unit 22. The illuminance sensor 65 receives, for example, the external light from the front of the user wearing the image display unit 20 through a hole provided in the front frame 27 of the image display unit 20, and outputs a detection value corresponding to an amount of received light (received light intensity).

The camera 61 acquires, for example, an image of an environment in a visual recognition range of the user corresponding to a direction of the image display unit 20 through the hole provided in the front frame 27 of the image display unit 20. The camera 61 is, for example, a digital camera including an imaging element such as a CCD or a CMOS, an imaging lens, and the like.

The image display unit 20 is coupled to the coupling device 10 by a coupling cable 40. The coupling device 10 includes a connector 11 in a box-shaped case (also referred to as a housing or a main body), and is coupled to a mobile information terminal 300 via the connector 11. The coupling device 10 receives the image output from the mobile information terminal 300 via the connector 11, controls the right display unit 22 and the left display unit 24 of the image display unit 20, and displays the received image to the user. Further, the coupling device 10 transmits sensor data from the nine-axis sensor 25 of the image display unit 20 and image data from the camera 61 to the mobile information terminal 300 via the connector 11.

The connector 11 of the coupling device 10 is, for example, a universal serial bus (USB) connector.

The mobile information terminal 300 includes a nine-axis sensor 301 that detects a direction and a movement of the mobile information terminal 300, a front camera 302 and a rear camera 303 that image-capture an environment, and a connector 304. Here, the front camera 302 and the rear camera 303 are respectively provided on a front surface (a surface illustrated in FIG. 1) and a back surface of the mobile information terminal 300. Note that, in the following description, the front camera 302 and the rear camera 303 are also referred to as “cameras 302 and 303”.

The nine-axis sensor 301 detects an acceleration (three-axis), angular velocity (three-axis), and geomagnetism (three-axis) of the mobile information terminal 300 and detects the direction and the movement of the mobile information terminal 300. Further, the cameras 302 and 303 acquire an image of the environment of the mobile information terminal 300 in each visual field range. In addition, the mobile information terminal 300 is coupled to the coupling device 10 via the connector 304.

The connector 304 of the mobile information terminal 300 is, for example, a universal serial bus (USB) connector, and the connector 304 and the connector 11 are coupled by a communication cable 42 which is, for example, a USB cable.

In the exemplary embodiment, the mobile information terminal 300 as the processing device is, for example, a smartphone. However, the mobile information terminal 300 may be a portable computer such as a tablet computer or a notebook computer including a nine-axis sensor and a camera.

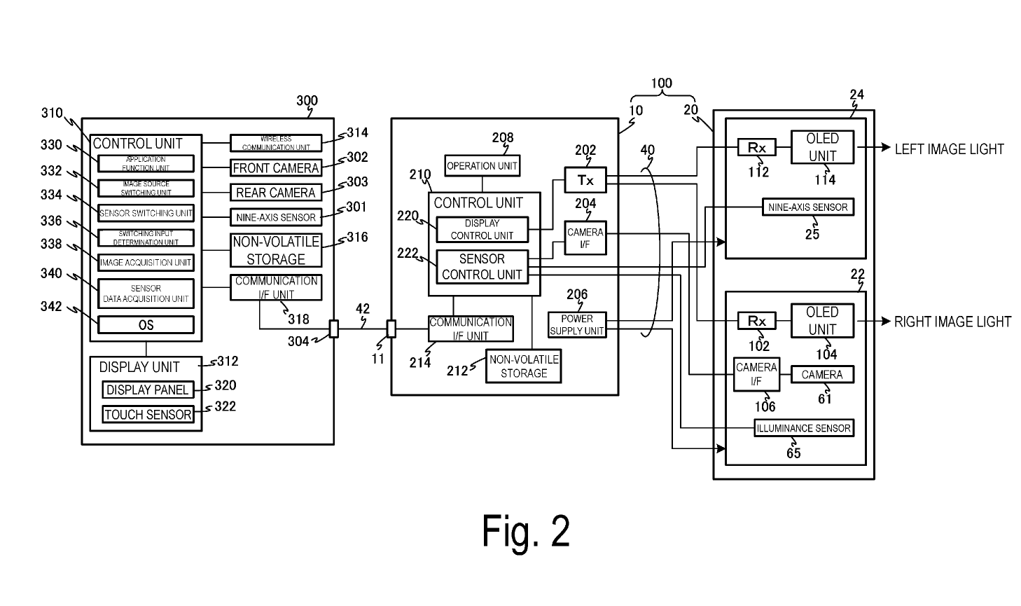

FIG. 2 is a block diagram illustrating a configuration of the HMD 100 and the mobile information terminal 300 constituting the display system 1. As described above, the HMD 100 is configured with the coupling device 10 and the image display unit 20 which are coupled by the coupling cable 40.

The right display unit 22 of the image display unit 20 includes a receiving unit (Rx) 102, an OLED unit 104, and a camera I/F (interface) 106. The Rx 102 receives a right image signal as an image signal for the right eye from the coupling device 10 and outputs the right image signal to the OLED unit 104. The OLED unit 104 is configured with, for example, an OLED (not illustrated) and a drive circuit (not illustrated) that drives the OLED. The OLED unit 104 outputs right image light toward the right light guide plate 26 based on the received right image signal. The camera I/F 106 receives a control signal to the camera 61 transmitted from the coupling device 10, and transmits an image signal from the camera 61 to the coupling device 10. An output signal of the illuminance sensor 65 is input to the coupling device 10 via the coupling cable 40.

The left display unit 24 of the image display unit 20 includes a receiving unit (Rx) 112 and an OLED unit 114. The receiving unit (Rx) 112 receives a left image signal as an image signal for the left eye from the coupling device 10 and outputs the left image signal to the OLED unit 114. As with the OLED unit 104, the OLED unit 114 is configured with, for example, an OLED (not illustrated) and a drive circuit (not illustrated) that drives the OLED. The OLED unit 114 outputs the left image light toward the left light guide plate 28 based on the received left image signal. An output signal of the nine-axis sensor 25 is input to the coupling device 10 via the coupling cable 40.

Each part of the image display unit 20 is operated by electric power supplied from a power supply unit 206 of the coupling device 10 via the coupling cable 40. The image display unit 20 may include a power supply circuit (not illustrated) for distributing the power supply from the power supply unit 206, performing voltage conversion, and the like.

The coupling device 10 includes a transmission unit (Tx) 202, a camera I/F 204, the power supply unit 206, an operation unit 208, a control unit 210, a non-volatile storage unit 212, and a communication I/F (interface) unit 214. The Tx 202 transmits the right image signal and the left image signal output from the control unit 210 respectively to the Rx 102 and the Rx 112 of the image display unit 20.

The non-volatile storage unit 212 is a storage device that stores data processed by the control unit 210 in a non-volatile manner. The non-volatile storage unit 212 is, for example, a magnetic recording device such as a hard disk drive (HDD) or a storage device using a semiconductor memory element such as a flash memory.

In the exemplary embodiment, for example, the communication I/F unit 214 performs wired communication with the mobile information terminal 300 in conformity with the USB communication standard. However, the communication with the mobile information terminal 300 performed by the communication I/F unit 214 is not limited to the wired communication according to the USB communication standard, and may be performed according to various other communication standards including wired and wireless communications.

In the exemplary embodiment, the power supply unit 206 supplies power to each part of the coupling device 10 and the image display unit 20 based on the power supplied from the mobile information terminal 300 via the communication cable 42 as the USB cable and the communication I/F unit 214 which are coupled to the connector 11. The power supply unit 206 may be configured to include a voltage conversion circuit (not illustrated), and be capable of supplying different voltages to each part of the coupling device 10 and the image display unit 20. Further, the power supply unit 206 may be configured by a device such as a logic circuit or an FPGA. Note that, the power supply unit 206 is not limited to the above configuration, and may supply power to each part of the coupling device 10 and the image display unit 20 based on the power from a chargeable battery (not illustrated) included in the coupling device 10 instead of the power supplied from the mobile information terminal 300.

The operation unit 208 is configured with buttons and switches that can be operated by a user, and is used to input instructions and data to the control unit 210.

The control unit 210 is, for example, a computer including a processor such as a central processing unit (CPU). The control unit 210 may be configured to include a read only memory (ROM) in which a program is written, a random access memory (RAM) for temporarily storing data, and the like. The control unit 210 includes a display control unit 220 and a sensor control unit 222 as functional elements (or functional units).

These functional elements included in the control unit 210 are implemented by, for example, the control unit 210 which is a computer executing a program. Note that, the computer program described above may be stored in any computer-readable storage medium.

Alternatively, all or a part of the functional elements included in the control unit 210 may be configured by hardware including one or more electronic circuit components. Such hardware may include programmed hardware, such as a digital signal processor (DSP), a field programmable gate array (FPGA), and the like.

The display control unit 220 receives image data from the mobile information terminal 300 via the communication I/F unit 214, and generates a right image signal and a left image signal for performing display on the image display unit 20. Further, the display control unit 220 transmits the generated right image signal and left image signal respectively to the Rx 102 and the Rx 112 of the image display unit 20 via the Tx 202. Thus, the image output from the mobile information terminal 300 is displayed to the user in the image display unit 20.

The sensor control unit 222 receives an output signal from the nine-axis sensor 25 and generates a sensor signal based on the received output signal. Then, the sensor control unit 222 transmits the generated sensor signal to the mobile information terminal 300 via the communication I/F unit 214.

Further, the sensor control unit 222 acquires an optical intensity signal corresponding to the received light intensity of the external light from the illuminance sensor 65. Then, the sensor control unit 222 controls the camera 61 based on the acquired light intensity signal via the camera I/F 204 and 106, and acquires an image captured by the camera 61. Further, the sensor control unit 222 transmits the image data of the image acquired from the camera 61 to the mobile information terminal 300 via the communication I/F unit 214.

The mobile information terminal 300 includes a control unit 310, a display unit 312, a wireless communication unit 314, a non-volatile storage unit 316, and a communication I/F (interface) unit 318 in addition to the nine-axis sensor 301, the front camera 302, and the rear camera 303.

The display unit 312 is configured with a display panel 320 and a touch sensor 322. The display panel 320 is, for example, a liquid crystal display panel, and the touch sensor 322 is, for example, a touch panel. The display unit 312, in addition to displaying an image on the display panel 320, displays a user interface (UI) such as a button on the display panel 320, and acquires an input from the user in cooperation with the touch sensor 322.

The cameras 302 and 303 are provided in a housing of the mobile information terminal 300 and acquire an image of the environment corresponding to the direction of the mobile information terminal 300. The cameras 302 and 303 are, for example, digital cameras including an imaging element such as a CCD or a CMOS, an imaging lens, and the like.

The nine-axis sensor 301 detects acceleration (three-axis), angular velocity (three-axis), and geomagnetism (three-axis) of the housing of the mobile information terminal 300, and detects the direction and movement of the mobile information terminal 300. The nine-axis sensor 301 is configured with, for example, a three-axis acceleration sensor and a three-axis gyro (angular velocity) sensor, which are motion sensors (inertial sensors), and a magnetic sensor that is a three-axis geomagnetic sensor.

The wireless communication unit 314 is a wireless transceiver. The control unit 310 accesses the Internet network via the wireless communication unit 314, and acquires various kinds of information including image information from various servers constituting the World Wide Web.

In the exemplary embodiment, for example, the communication I/F unit 318 performs wired communication with the coupling device 10 in conformity with the USB communication standard. However, the communication with the coupling device 10 performed by the communication I/F unit 318 is not limited to the wired communication according to the USB communication standard, and may be performed according to various other communication standards including wired and wireless communications.

The non-volatile storage unit 316 is configured to store programs to be executed by the control unit 310 and data to be processed by the control unit 310 in a non-volatile manner. The non-volatile storage unit 316 is, for example, a magnetic recording device such as an HDD or a storage device using a semiconductor memory element such as a flash memory.

The non-volatile storage unit 316 stores an operating system (OS) as a basic control program executed by the control unit 310, an application program that operates with the OS as a platform, and the like. Further, the non-volatile storage unit 316 stores data to be processed when the application program is executed and data of the processing result.

The control unit 310 includes a processor (not illustrated) such as a central processing unit (CPU) and a microcomputer, and controls each part of the mobile information terminal 300 by executing the program by the processor. The control unit 310 may include a read only memory (ROM) that stores a control program to be executed by the processor in a non-volatile manner, and a random access memory (RAM) that constitutes a work area of the processor. Then, the control unit 310 includes, as functional elements (or functional units), an application function unit 330, an image source switching unit 332, a sensor switching unit 334, a switching input determination unit 336, an image acquisition unit 338, a sensor data acquisition unit 340, and an OS 342.

These functional elements included in the control unit 310 are implemented by the control unit 310 which is a computer executing a program. Note that, the computer program described above may be stored in the non-volatile storage unit 316, or may be stored in any computer-readable storage medium.

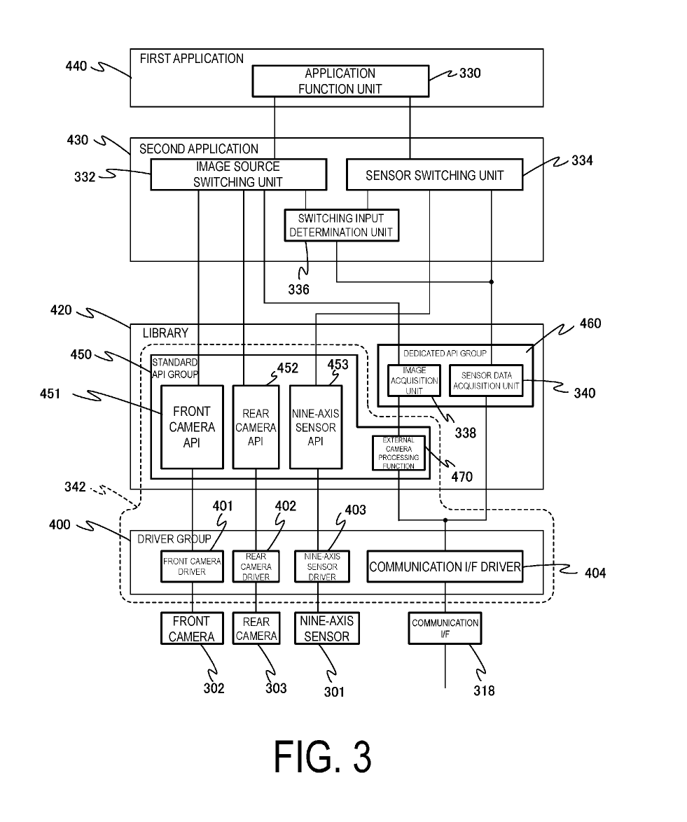

The application function unit 330 is implemented by the control unit 310, which is a computer executing a first application program 440 (FIG. 3), and runs on the OS 342 (that is, runs in cooperation with the OS 342). The first application program 440 is, for example, an existing application program designed to run using the front camera 302, the rear camera 303, and the nine-axis sensor 301 built in the mobile information terminal 300. Note that, hereinafter, an application program and a functional element implemented by executing an application program are also referred to as an “application” or an “app”.

The OS 342 is implemented by the control unit 310, for example, executing an OS program stored in advance in the non-volatile storage unit 316. The OS 342 includes a device driver for operating various devices including the nine-axis sensor 301, the front camera 302, the rear camera 303, and the communication I/F unit 318 included in the mobile information terminal 300. Further, the OS 342 provides various application programming interfaces (APIs, Application Programming Interfaces) to the applications of the application function unit 330 and the like which are executed by the control unit 310. Generally, the API is a software function that returns data and status corresponding to a command and an argument as a response by providing the command code and the argument.

In general, in a typical mobile information terminal such as a smartphone including a built-in camera and a nine-axis sensor, the cooperative operation with an external device including a camera and a nine-axis sensor is not considered. For this reason, in general, in the OS of a typical mobile information terminal including the built-in camera and the built-in nine-axis sensor, an API for handling the built-in camera and the built-in nine-axis sensor is provided, but an API that handles the camera and the nine-axis sensor included in the external device is not provided.

Therefore, the control unit 310 of the mobile information terminal 300 in the exemplary embodiment includes an image acquisition unit 338 and a sensor data acquisition unit 340. The image acquisition unit 338 provides a programming interface that acquires an image from the camera 61 included in the HMD 100 received via the communication I/F unit 318 to complement the function of the OS 342 or to add to the function of the OS 342. The sensor data acquisition unit 340 also provides a programming interface that acquires sensor data from the nine-axis sensor 25 included in the HMD 100 received via the communication I/F unit 318 to complement the function of the OS 342 or to add to the function of the OS 342. The image acquisition unit 338 and the sensor data acquisition unit 340 are, for example, APIs. Note that, in the above description and the following description, the term “complements the function of the OS 342” refers to adding a programming interface that implements functions different from that of the API implementing various functions provided by the OS 342 in the same manner as the API to the API. Here, “in the same manner as the API” means that, for example, a call can be made from the application program in the same manner as the API provided by the OS 342. Note that, the programming interface added to complement the functions of the OS 342 is added, for example, to form a part of a library 420 in the software configuration illustrated in FIG. 3.

Then, in particular, the mobile information terminal 300 constituting the display system 1 of the exemplary embodiment includes the image source switching unit 332, the sensor switching unit 334, and the switching input determination unit 336.

The image source switching unit 332 operates in response to input of a switching instruction when the display device including the camera and the nine-axis sensor, for example, the HMD 100, is coupled to the mobile information terminal 300. When the switching instruction is input, the image source switching unit 332 switches between the image from the cameras 302 and/or 303 and the image from the camera 61 included in the HMD 100, and provides the image to the application function unit 330. Specifically, the image source switching unit 332 determines whether the HMD 100 has been coupled to the mobile information terminal 300 via the communication I/F unit 318. Then, when the HMD 100 is coupled, the image source switching unit 332 switches the image source of the image provided to the application function unit 330 from the camera 302 and/or 303 to the camera 61 when the switching input determination unit 336 receives a notification indicating that the switching instruction has been input.

More specifically, the image source switching unit 332 switches the image source as follows. First, when the mobile information terminal 300 is activated, the OS 342 dynamically allocates, for example, a first data structure (hereinafter referred to as a first structure) for storing image data acquired from the cameras 302 and/or 303, in the non-volatile storage unit 316. Then, the OS 342 stores a head address of the first structure at a first predetermined address in the non-volatile storage unit 316. The application function unit 330 can acquire image data from the cameras 302 and/or 303 by referring to the head address stored in the first predetermined address and reading in the image data stored in the first structure starting from the first address.

On the other hand, when the HMD 100 is coupled to the mobile information terminal 300, the image acquisition unit 338 dynamically allocates a second data structure (hereinafter referred to as a second structure) for storing image data acquired from the camera 61 of the HMD 100, in the non-volatile storage unit 316. Then, the image acquisition unit 338 stores a head address of the second structure at a second predetermined address in the non-volatile storage unit 316.

In contrast, when the image source switching unit 332 receives a notification indicating that the switching instruction has been input from the switching input determination unit 336, the image source switching unit 332 refers to the head address of the second structure stored in the second predetermined address. Then, the image source switching unit 332 rewrites the head address of the first data structure stored in the first predetermined address to the head address of the second structure stored in the second predetermined address. Accordingly, the application function unit 330 can access the second structure without changing the program of the application function unit 330, and the image source of the image used by the application function unit 330 can be switched to the camera 61. That is, even when the application function unit 330 is an existing application that accesses the first structure using the head address stored in the first predetermined address, the image source can be switched without changing the program of the application function unit 330.

The sensor switching unit 334 operates in response to input of the switching instruction when the display device including the camera and the nine-axis sensor, for example, the HMD 100, is coupled to the mobile information terminal 300. When the switching instruction is input, the sensor switching unit 334 switches between the sensor data from the nine-axis sensor 301 and the sensor data from the nine-axis sensor 25 included in the HMD 100, and provides the switching instruction to the application function unit 330. Specifically, the sensor switching unit 334 determines whether the HMD 100 has been coupled to the mobile information terminal 300 via the communication I/F unit 318. Then, when the HMD 100 is coupled, the sensor switching unit 334 switches the sensor data when a notification indicating that the switching instruction is input is received from the switching input determination unit 336. That is, the sensor switching unit 334 switches between the sensor data from the nine-axis sensor 301 and the sensor data from the nine-axis sensor 25, and provides the switched sensor data to the application function unit 330. This switching can be performed by rewriting the head address of the data structure related to the nine-axis sensor 301 stored at a predetermined address by the OS 342 to the head address of the data structure related to the nine-axis sensor 25, as in the example of the operation of the image source switching unit 332 described above.

The switching input determination unit 336 detects the input of the switching instruction from the user, and notifies the image source switching unit 332 and the sensor switching unit 334 of the input of the switching instruction (that is, notification indicating that the switching instruction has been input). The input of the switching instruction is given, for example, by the user tapping the right holding portion 21 of the image display unit 20 with a finger. For example, the switching input determination unit 336 receives sensor data from the nine-axis sensor 25 via the sensor data acquisition unit 340, detects whether or not there is an impulse acceleration change in a specific direction in the image display unit 20, and determines whether the tapping has been performed.

More specifically, the switching input determination unit 336 detects the number of consecutive tappings at predetermined time intervals, and sends a notification indicating that the switching instruction has been input and information about the number of tappings to the image source switching unit 332 and the sensor switching unit 334. Then, for example, if the tapping is performed once, the image source switching unit 332 and the sensor switching unit 334 switch the image source and the nine-axis sensor to be used, to the cameras 302 and 303 and the nine-axis sensor 301 of the mobile information terminal 300. On the other hand, for example, if the tapping is performed twice, the image source switching unit 332 and the sensor switching unit 334 switch the image source and the nine-axis sensor to be used, to the camera 61 and the nine-axis sensor 25 of the HMD 100.

Alternatively, the switching operation of the image source switching unit 332 and the sensor switching unit 334 may be performed in accordance with a direction of tapping by the user to the HMD 100 (for example, whether a tap is from the right side of the HMD 100 or from the left side). Specifically, the switching input determination unit 336 detects performance of the tapping and the direction of the tapping based on the sensor data from the nine-axis sensor 25 of the HMD 100. Then, the switching input determination unit 336 sends a notification indicating that the switching instruction has been input and the information about the direction of the tapping to the image source switching unit 332 and the sensor switching unit 334. In response to this, for example, the image source switching unit 332 and the sensor switching unit 334 switch the image source and the sources of the sensor data so as to be in a predetermined state in accordance with the direction of the tapping. Note that, the tapping is an example, and the switching instruction may be any operation that can be detected by the nine-axis sensor 301, such as the head of the user shaking, tilting, turning, and the like.

Further, alternatively, the input of the switching instruction may be, for example, an occurrence of the event where “the HMD 100 has been coupled to the mobile information terminal 300”. In this case, for example, the switching input determination unit 336 may automatically detect whether the event where “the HMD 100 has been coupled to the mobile information terminal 300” has occurred by acquiring the status information of the communication I/F unit 318. In this case, when the HMD 100 is coupled, the image source switching unit 332 and the sensor switching unit 334 can switch the image source and the nine-axis sensor to be used, to the camera 61 and the nine-axis sensor 25 of the HMD 100. Further, when the HMD 100 is not coupled, the image source switching unit 332 and the sensor switching unit 334 can switch the image source and the nine-axis sensor to be used, to the cameras 302 and 303 and the nine-axis sensor 301 of the mobile information terminal 300.

Further, in the exemplary embodiment, the image source switching unit 332, the sensor switching unit 334, and the switching input determination unit 336 are realized by the control unit 310 executing a second application 430 (FIG. 3) different from the first application 440 that implements the application function unit 330. The second application may be a plug-in program or a program that functions as middleware in the sense of interposing between the OS 342 and the application function unit 330 and changing the access from the application function unit 330 to the OS 342. That is, the image source switching unit 332 and the sensor switching unit 334 are implemented by the second application 430 that functions as a plug-in program or middleware that runs on the OS 342 to control data transfer between the first application 440 and the OS 342.

According to the above configuration, in the exemplary embodiment, the image source and the sensor to be used are switched only by executing the second application by the control unit 310, without modifying the programs of the existing first application 440 and the OS 342. Note that, the automatic detection of the coupling status of the HMD 100 in the switching input determination unit 336 described above as an example can, for example, switch the validity/invalidity at a setting screen of the second application 430 that implements the switching input determination unit 336. Such setting screen can be displayed on the display unit 312 when the second application 430 is activated, for example.

FIG. 3 is a diagram illustrating the configuration of software executed by the control unit 310 of the mobile information terminal 300. The software includes a driver group 400, the library 420, the second application 430, and the first application 440. The library 420 is configured with various APIs and processing functions used by the application to control various devices. The API is a software function and provides a device-independent program interface. In contrast, the processing function includes reference of a physical address and the like in a part of an argument, and provides a device dependent program interface.

Specifically, the library 420 includes a standard API group 450 provided by the OS 342, and a dedicated API group 460 that provides control of various devices of the HMD 100 to complement the OS 342 or to add to the function of the OS 342. Further, the library 420 also includes an external camera processing function 470.

The driver group 400, the standard API group 450, and the external camera processing function 470 are provided by the OS 342. In the illustrated example, the driver group 400 is configured with a device driver for various devices built in the mobile information terminal 300. Specifically, the driver group 400 includes a front camera driver 401 that controls the front camera 302, a rear camera driver 402 that controls the rear camera 303, and a nine-axis sensor driver 403 that controls the nine-axis sensor 301. The driver group 400 also includes a communication I/F driver 404 that controls the communication I/F unit 318.

The standard API group 450 includes a front camera API 451 for accessing the front camera driver 401 to control the front camera 302, and a rear camera API 452 for accessing the rear camera driver 402 to control the rear camera 303. The standard API group 450 also includes a nine-axis sensor API 453 for accessing the nine-axis sensor driver 403 to control the nine-axis sensor 301.

The external camera processing function 470 controls the camera of the external device and acquires image data via the communication I/F unit 318.

The dedicated API group 460 includes the image acquisition unit 338 and the sensor data acquisition unit 340. As described above, the image acquisition unit 338 is an API that provides a program interface for acquiring image data from the camera 61 of the HMD 100 serving as the external device via the communication I/F unit 318. Further, as described above, the sensor data acquisition unit 340 is an API that provides a program interface for acquiring sensor data from the nine-axis sensor 25 of the HMD 100 serving as the external device via the communication I/F unit 318.

The image acquisition unit 338 and the sensor data acquisition unit 340, which are APIs constituting the dedicated API group 460, can be provided, for example, from the manufacturer of the HMD 100 in the form of a so-called software development kit (SDK).

As described above, the second application 430 is a program that runs on the OS 342 to control data transfer between the first application 440 and the OS 342, or a program that functions as middleware. The second application 430 is executed by the control unit 310 to implement the image source switching unit 332, the sensor switching unit 334, and the switching input determination unit 336.

The application function unit 330 implemented by the first application 440 can be any application designed to run on the OS 342. The first application 440 may be, for example, an existing application configured to use the cameras 302 and 303 and the nine-axis sensor 301 built in the mobile information terminal 300.

With the software configuration described above, in the mobile information terminal 300 of the exemplary embodiment, even if the first application 440 is an existing application as described above, the camera 61 and the nine-axis sensor 25 of the HMD 100 can be used via the second application 430.

Therefore, in the mobile information terminal 300 of the exemplary embodiment, it is possible to perform the cooperative operation of the HMD 100 and the mobile information terminal 300 accompanied with switching of the camera and the nine-axis sensor without recreating the existing first application 440 and/or the OS 342.

Note that, the image acquisition unit 338, the sensor data acquisition unit 340, and the second application 430 of the dedicated API group 460 can be downloaded from the HMD 100 and installed when the HMD 100 is coupled to the mobile information terminal 300. Specifically, the HMD 100 includes the image acquisition unit 338, the sensor data acquisition unit 340, and a nonvolatile storage unit (not illustrated) in which the software programs of the second application 430 are stored. When the HMD 100 is coupled, the image acquisition unit 338, the sensor data acquisition unit 340, and the second application 430 can be downloaded by a download application installed in advance in the mobile information terminal 300.

As described above, the mobile information terminal 300 of the exemplary embodiment as the processing device includes the cameras 302 and 303, the nine-axis sensor 301, the control unit 310 that is a calculation unit that executes the application program, and the communication I/F unit 318 that is a communication unit that communicates with the external device. The HMD 100, which is a display device including the camera 61 and the nine-axis sensor 25, is coupled to the mobile information terminal 300 via the communication I/F unit 318. Then, the mobile information terminal 300 includes the image source switching unit 332 and the sensor switching unit 334. When the HMD 100 is coupled, the image source switching unit 332 switches between the image from the cameras 302 and 303 and the image from the camera 61 received via the communication I/F unit 318 in response to the input of the switching instruction, and provides the image to the application program. Further, when the HMD 100 is coupled, the sensor switching unit 334 switches between the data from the nine-axis sensor 301 and the data from the nine-axis sensor 25 via the communication I/F unit 318 in response to the input of the switching instruction, and provides the data to the application program.

According to the mobile information terminal 300, the display system 1, and the second application program 430 which implements the image source switching unit 332 and the sensor switching unit 334 of the aspect of the invention, the cooperative operation of the HMD 100 and the mobile information terminal 300 can be smoothly performed. Further, according to the mobile information terminal 300 and the like of the aspect of the invention, it is not necessary to recreate the existing first application 440 or the OS 342 for implementing the cooperative operation.

Specifically, the mobile information terminal 300 further includes the switching input determination unit 336 that determines whether a switching instruction has been input based on the sensor data from the nine-axis sensor 25 included in the HMD 100. Thus, the mobile information terminal 300 can easily switch between the cameras 302 and 303, the nine-axis sensor 301, the camera 61, and the nine-axis sensor 25 only by the user performing an operation detectable by the nine-axis sensor 25 included in the HMD 100.

The mobile information terminal 300 of the invention includes the image acquisition unit 338 that provides a programming interface that acquires an image from the camera 61 included in the HMD 100 received via the communication I/F unit 318 to complement or add to the function of the OS 342. Further, the mobile information terminal 300 includes the sensor data acquisition unit 340. The sensor data acquisition unit 340 provides a programming interface that acquires the sensor data from the nine-axis sensor 25 included in the HMD 100 received via the communication I/F unit 318 to complement or add to the function of the OS 342. Accordingly, in the mobile information terminal 300, even in a case where the function of acquiring the outputs of the camera 61 and the nine-axis sensor 25 of the HMD 100 is not provided by the OS 342, the cooperative operation between the HMD 100 and the mobile information terminal 300 can be performed smoothly.

Further, in the mobile information terminal 300 of the invention, the image source switching unit 332 and the sensor switching unit 334 are implemented by the second application program 430 running on the OS 342. The second application program 430 functions as a plug-in program or middleware for controlling data transfer between the first application program 440 and the OS 342.

Accordingly, the image source switching unit 332 and the sensor switching unit 334 are implemented as applications executed by the mobile information terminal 300, and thus, a smooth cooperative operation of the HMD 100 and the mobile information terminal 300 can be easily implemented.

Note that, the invention is not limited to the exemplary embodiment configured as described above, and can be implemented in various aspects, as long as the aspects fall within the scope of the invention.

For example, in the above exemplary embodiment, it is configured that, as the sensors, the nine-axis sensor 301 included in the mobile information terminal 300 and the nine-axis sensor 25 included in the HMD 100 are switched, but the configuration is not limited to this. The sensors that are switching symmetry by the sensor switching unit 334 may be various sensors that can be replaced with each other mounted on the mobile information terminal 300 and the HMD 100. For example, the illuminance sensor may be provided in the mobile information terminal 300, and the illuminance sensor and the illuminance sensor 65 included in the HMD 100 can be switched by the sensor switching unit 334. In this case, for example, the switching input determination unit 336 can detect that the user suddenly changes the amount of external light incident on the illuminance sensor 65 by covering the illuminance sensor 65 with a hand and the like, and determine that the switching instruction has been input.

Moreover, for example, one of the HMD 100 and the mobile information terminal 300 may not include the camera or the nine-axis sensor (or another type of sensor that can be replaced with each other). In this case, for example, when the HMD 100 does not include the camera 61, the image source switching unit 332 may not perform the switching operation of the image source even if the switching instruction is received from the switching input determination unit 336. That is, the image source switching unit 332 can continuously provide image data from the camera 302 or 303 included in the mobile information terminal 300 to the application function unit 330 without performing the switching operation. In this case, the image source switching unit 332 and the sensor switching unit 334 can inquire the OS 342 (for example, by calling a corresponding API) to detect whether the mobile information terminal 300 includes the camera and the nine-axis sensor respectively. Further, the image source switching unit 332 and the sensor switching unit 334 can inquire the HMD 100 via the communication I/F unit 318 to detect whether the HMD 100 includes the camera and the nine-axis sensor respectively.

Further, for example, cameras and a plurality of types of sensors may be provided in both the HMD 100 and the mobile information terminal 300. For example, both the HMD 100 and the mobile information terminal 300 may include the camera, the nine-axis sensor, and the illuminance sensor. In this case, the sensor switching unit 334 can switch between the sensor data from the nine-axis sensor and the illuminance sensor of the HMD 100 and the sensor data from the nine-axis sensor and the illuminance sensor of the mobile information terminal 300 according to the switching instruction. Alternatively, for example, the user may set to which type of sensor included in both the HMD 100 and the mobile information terminal 300 the above switching is performed for the second application 430 that implements the sensor switching unit 334. In this case, the sensor switching unit 334 can switch the sensor data only for the sensor of the type designated to perform the switching operation in the above setting within the nine-axis sensor and the illuminance sensor.

Further, for example, a switching state of the image source switching unit 332 and the sensor switching unit 334, when the HMD 100 is coupled to the mobile information terminal 300 and the cooperative operation is performed, may be automatically reproduced when the HMD 100 is coupled to the mobile information terminal 300 a next time. The switching state referred to here is the difference in the output source of the image data and the sensor data provided by the image source switching unit 332 and the sensor switching unit 334 to the application function unit 330, wherein the output source may be the HMD 100 or the mobile information terminal 300. Specifically, the second application 430 stores the setting of the switching state of the image source switching unit 332 and the sensor switching unit 334 when the HMD 100 is coupled to the mobile information terminal 300 to perform the cooperative operation in the non-volatile storage unit 316. When the HMD 100 is coupled to the mobile information terminal 300 the next time, the second application 430 can set the image source switching unit 332 and the sensor switching unit 334, with reference to the setting, such that the image source switching unit 332 and the sensor switching unit 334 enter the switching state according to the setting.

Further, in the exemplary embodiment described above, the switching input determination unit 336 determines whether or not the switching instruction is input by detecting the change of the acceleration in a specific direction with the nine-axis sensor 25 or detecting the coupling event of the HMD 100 with the communication I/F unit 318, but the switching input determination unit 336 is not limited to this. For example, the switching input determination unit 336 can determine that the switching instruction has been input according to a specific command being input from the user in the processing executed in the application function unit 330. Such processing for a specific command can be provided, for example, as an add-on program for the first application program 440 that implements the application function unit 330.

While a configuration in which the image display unit 20 and the coupling device 10 are separated and coupled via the coupling cable 40 is described as an example in the above exemplary embodiment, the coupling device 10 and the image display unit 20 may be coupled by a wireless communication line.

Further, at least a part of the elements illustrated in FIG. 2 may be implemented by hardware, or may be a configuration implemented by the cooperation of hardware and software, and is not limited to the configuration in which independent hardware resources are arranged as illustrated in the drawings.

The entire disclosure of Japanese Patent Application No. 2017-246913, filed Dec. 22, 2017 is expressly incorporated by reference herein.

What is claimed is:

1. A processing device that includes a camera, a sensor, a calculation unit that executes an application program, and a communication unit that communicates with an external device, the processing device comprising:
an image source switching unit configured, when a display device including a camera and a sensor is coupled, to switch between an image from the camera included in the processing device and an image from the camera included in the display device received via the communication unit, the image source switching unit providing the images to the application program in response to input of a switching instruction; and
a sensor switching unit configured, when the display device is coupled, to switch between sensor data from the sensor included in the processing device and sensor data from the sensor included in the display device received via the communication unit, the sensor switching unit providing the sensor data to the application program in response to input of the switching instruction.

2. The processing device according to claim 1, further comprising:
a switching input determination unit that determines whether a switching instruction has been input based on the sensor data from the sensor included in the display device.

3. The processing device according to claim 1, comprising:
an image acquisition unit that provides a programming interface for acquiring an image from the camera included in the display device received via the communication unit to complement a function of an operating system included in the processing device; and
a sensor data acquisition unit that provides a programming interface for acquiring sensor data from the sensor included in the display device received via the communication unit to complement a function of an operating system included in the processing device.

4. The processing device according to claim 1, wherein
the image source switching unit and the sensor switching unit are implemented by a plug-in program that operates on an operating system to control data transfer between the application program and the operating system, or by an application program that functions as middleware.

5. A display system, comprising:
a processing device according to claim 1 that includes a motion sensor as the sensor; and
a display device that includes a camera and a motion sensor, and includes a display region configured to enable visual recognition of an outside scene to generate an image in front of a line of sight of a user by the display region when the display device is mounted on a head of the user.

6. A non-transitory computer-readable storage medium storing a program that comprising instructions to be executed by a processing device when the processing device coupled with a display device, the non-transitory computer-readable storage medium comprising:
detecting a instruction to the display device;
providing an image to an application from one of a first camera of the processing device and a second camera of the display device by the instruction; and
providing a sensor data to the application from one of a first sensor of the processing device and a second sensor of the display device by the instruction.
